(19) United States
(12) Patent Application Publication
(10) Pub. No.: US 2023/0401240 A1
(43) Pub. Date: Dec. 14, 2023

(54) SYSTEM AND METHOD FOR ENTERPRISE PROCESS CONSTRUCTION

(71) Applicant: CHING-FENG LEE, Taichung City (TW)

(72) Inventor: CHING-FENG LEE, Taichung City (TW)

(21) Appl. No.: 17/835,909

(22) Filed: Jun. 8, 2022

(51) Int. Cl. G06F 16/28; G06F 16/25

(52) U.S. Cl. CPC G06F 16/287; G06F 16/252; G06F 16/288

(57) ABSTRACT

An enterprise process construction system and an enterprise process construction method are provided. The enterprise process construction system includes a server being connected to an electronic device. The electronic device is connected to the server through an interactive program installed in the electronic device. The interactive program provides a software construction interface to perform a plurality of software construction actions, the server provides a plurality of platforms for selection through the interactive program, the server provides a plurality of process construction templates for selection, and multiple pieces of first information are imported based on one of a plurality of data structure templates. The server generates a first software according to information collected by the at least one page of the process construction template in the software construction interface provided by the electronic device, the selected platform, and the multiple pieces of first information.

### FIELD OF THE DISCLOSURE

The present disclosure relates to an enterprise process construction system and an enterprise process construction method, and more particularly to an enterprise process construction system and an enterprise process construction method that can be easily constructed and adjusted.

### BACKGROUND OF THE DISCLOSURE

Currently, in order to realize digitalization of company processes, a considerable amount of time needs to be dedicated to software planning and design, so that an overall design period cannot be shortened by any significant extent.

Therefore, how to provide an enterprise process construction system that can shorten the design period and can be easily constructed and adjusted has become one of the important issues to be addressed in the industry.

### SUMMARY OF THE DISCLOSURE

In response to the above-referenced technical inadequacies, the present disclosure provides an enterprise process construction system and an enterprise process construction method.

In one aspect, the present disclosure provides an enterprise process construction system. The enterprise process construction system includes a server. The server is connected to an electronic device. The electronic device is connected to the server through an interactive program installed in the electronic device. The interactive program provides a software construction interface to perform a plurality of software construction actions. The server provides a plurality of platforms for selection through the interactive program. The server provides a plurality of process construction templates for selection, and multiple pieces of first information are imported based on one of a plurality of data structure templates. A user group and an organization role group are established in the software construction interface of the interactive program. The user group includes a plurality of users. The organization role group includes a plurality of organization roles and a plurality of workflows that correspond to the plurality of organization roles. Each of the plurality of users is correspondingly associated with at least one of the plurality of organization roles in the organization role group. The server provides a workflow processing interface to construct the plurality of workflows, so as to respectively process the multiple pieces of first information. The workflow processing interface includes a plurality of information processing elements. The process construction template includes at least one page. The at least one page includes a plurality of visualization elements. Each of the visualization elements includes an adjustment parameter, and the plurality of visualization elements are interconnected with the plurality of workflows to show the first information or processed first information. The server generates a first software according to information collected by the at least one page of the process construction template in the software construction interface provided by the electronic device, the selected platform, and the multiple pieces of first information.

In another aspect, the present disclosure provides an enterprise process construction method. The enterprise process construction method includes the following steps: providing a software construction interface; selecting a process construction template; establishing a user group, the user group including a plurality of users; establishing an organization role group, wherein the organization role group includes a plurality of organization roles, and a plurality of workflows are established according to the organization roles; establishing at least one workflow content of each of the workflows; correspondingly associating each of the users with at least one of the organizational roles; importing multiple pieces of first information based on a data structure template; providing a workflow processing interface to process the plurality of first information; establishing at least one information processing workflow by using one of the plurality of first information in the information processing interface, wherein the workflow processing interface includes at least one information processing element; establishing a page of the process construction template, wherein the page includes a plurality of visualization elements, and each of the visualization elements includes at least one adjustment parameter, so that the page presents processed first information after the multiple pieces of first information undergo the at least one information processing workflow; and generating a first software corresponding to the at least one platform.

Therefore, the enterprise process construction system and the enterprise process construction method provided by the present disclosure can effectively improve user efficiency in designing software programs for different platforms. Since the software programs for the different platforms can be quickly established based on modularized templates, information processing methods, information processing structures, etc., design costs can be significantly reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an enterprise process construction system according to a first embodiment of the present disclosure;

FIG. 2 is a schematic view showing the enterprise process construction system providing different platforms according to the first embodiment of the present disclosure;

FIG. 3 is a schematic view showing a software construction interface providing a plurality of pages;

FIG. 4 is a schematic view of the software construction interface of the enterprise process construction system according to the first embodiment of the present disclosure;

FIG. 5 is a schematic view of a workflow processing interface according to the first embodiment;

FIG. 6 is a schematic view of a user group building page according to the first embodiment;

FIG. 7 is a schematic view of workflows of an organization role group according to the first embodiment;

FIG. 8 is a schematic view showing design parameters of a first software of the present disclosure being transmitted to a server for compilation; and

FIG. 9 is a flowchart of an enterprise process construction method according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

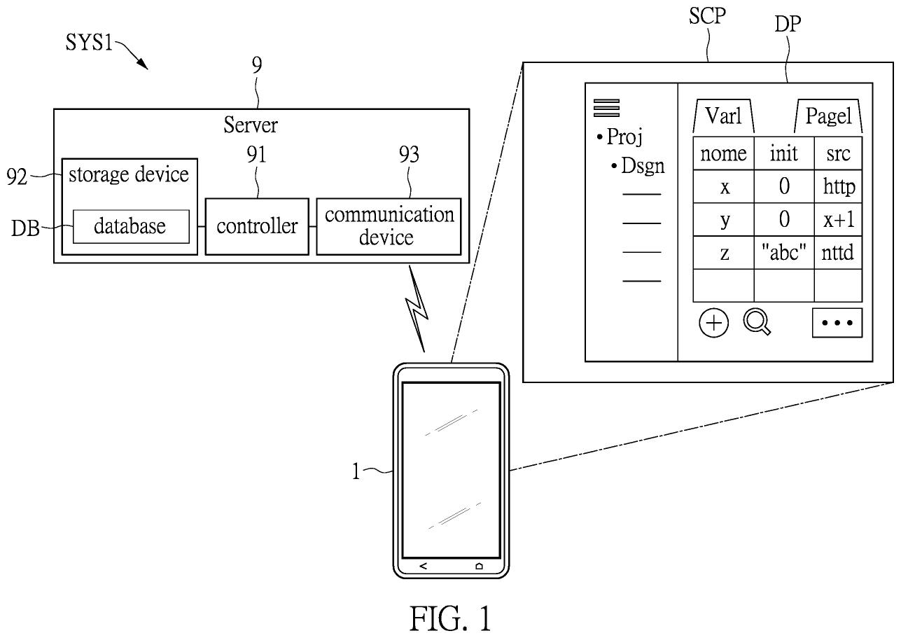

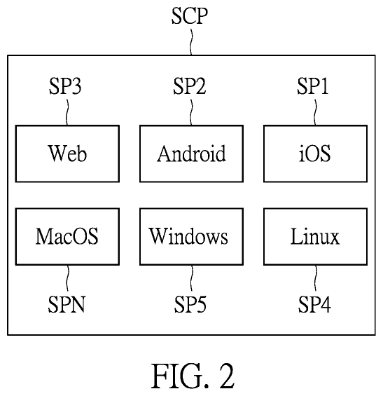

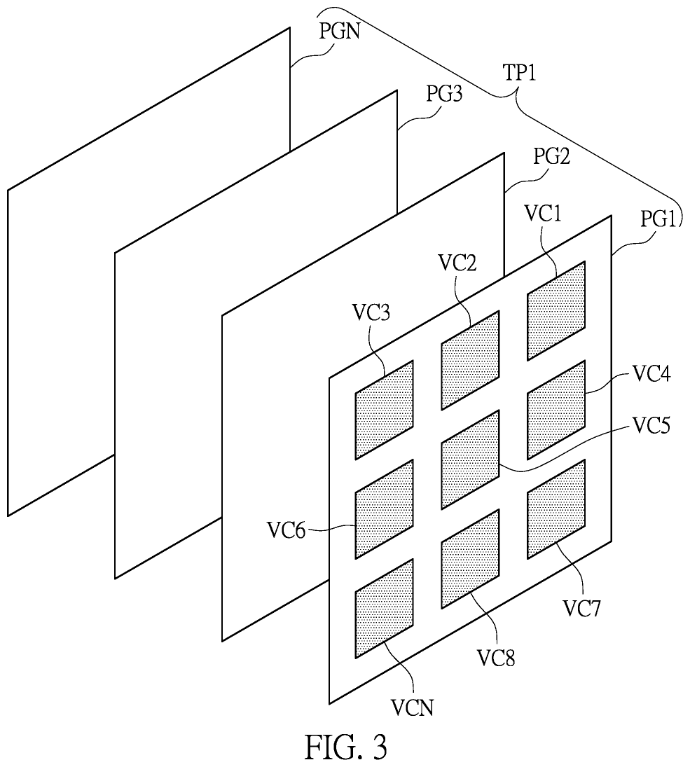

References are made to FIG. 1, FIG. 2 and FIG. 3. FIG. 1 is a schematic view of an enterprise process construction system according to a first embodiment of the present disclosure. FIG. 2 is schematic view that shows that the enterprise process construction system of the first embodiment of the present disclosure provides a plurality of platforms. FIG. 3 is a schematic view of process construction templates that provide a plurality of pages.

Referring to FIG. 1, an enterprise process construction system SYS1 of this embodiment includes a server 9. The server 9 is connected to an electronic device 1. The electronic device 1 can be connected to and interact with the server 9 through an interactive program installed in the electronic device 1.

The server 9 includes a controller 91, a storage device 92, and a communication device 93. The controller 91 is connected to the storage device 92 and the communication device 93. The storage device 92 includes a database DB.

The electronic device 1 can be a desktop computer, a smart phone, a tablet computer or a wearable electronic device. The controller 91 can be a central processing unit (CPU), an application-specific integrated circuit (ASIC) or a microprocessor (MCU). The storage device 92 can be a flash memory, a read-only memory (ROM), a programmable read-only memory, an electrically rewritable read-only memory, an erasable programmable read-only memory, or an electrically-erasable programmable read-only memory. The communication device 93 may include a wired communication unit (not shown) and a wireless communication unit (not shown). When the communication device 93 is a wireless communication unit, the communication device 93 can be a WI-FI ° communication unit, a BLUETOOTH ° communication unit, a ZIGBEE ° communication unit, a LoRa communication unit, a Sigfox communication unit or an NB-IoT communication unit.

Reference is made to FIG. 2. The interactive program in the electronic device 1 provides a software construction interface SCP for performing a plurality of software construction actions. The server 9 provides a plurality of platforms SP1-SPN for selection through the interactive program. In this embodiment, the electronic device 1 has a wired communication module (not shown) or a wireless communication module (not shown), so as to be in communication with the communication device 93 of the server 9.

Reference is made to FIG. 3. When one of the platforms SP1-SPN is selected, the server 9 provides a plurality of process construction templates TP1 for selection. In addition, a user can select multiple ones of the platforms and perform process construction at the same time. For example, an ANDROID® platform and an IOS® platform can be simultaneously selected. The process construction templates TP1 for the ANDROID® platform and the IOS® platform are stored in the database DB of the server 9.

In addition, in this embodiment, the enterprise process construction system SYS1 can provide a plurality of data structure templates for the user to select, and can also allow the user to import or receive multiple pieces of first information. Input of the first information can be performed according to one of the data structure templates provided by the server 9, or can be performed according to a user-defined data structure template. In other words, the enterprise process construction system SYS1 of the present embodiment allows the user to process data freely.

In this embodiment, the first information is Internet of Things information (IoT) collected from Internet of Things devices. To be more specific, the first information can be basic detection information that is unorganized or unprocessed, or can be information having a format that is clearly defined by other devices. Furthermore, the user can input data of various data structures for editing and analysis.

In other words, in the enterprise process construction system SYS1 of this embodiment, the platforms SP1-SPN and the data structure are pre-standardized to reduce the complexity of software construction. In addition, the enterprise process construction system SYS1 of this embodiment also provides a user-defined data structure and a user-defined process structure platform.

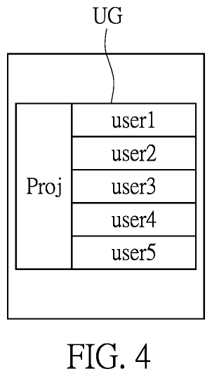

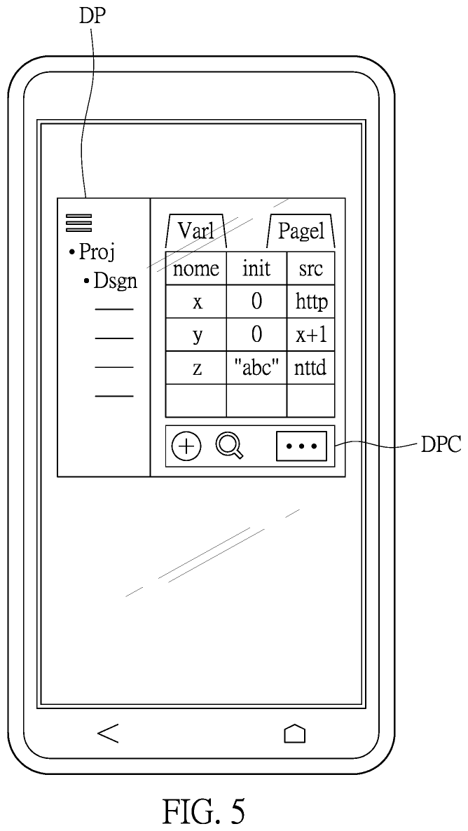

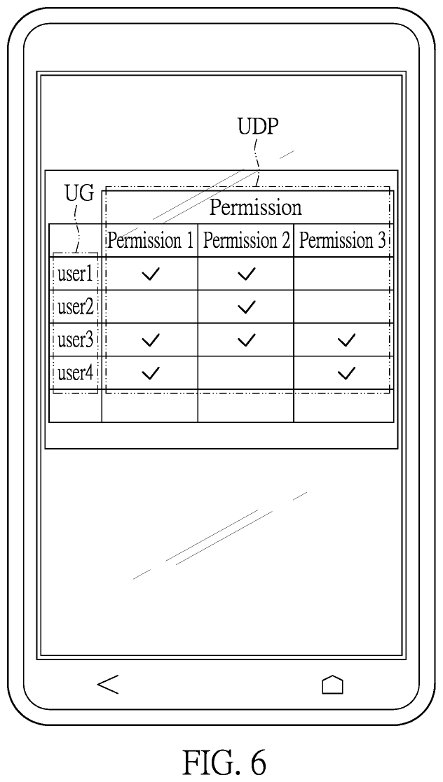

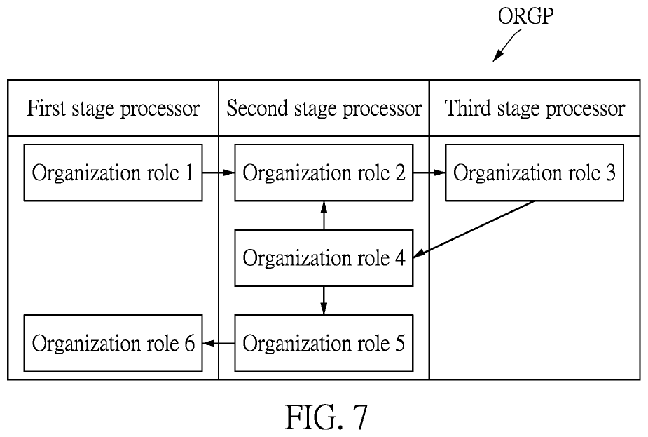

References are made to FIG. 4, FIG. 5, FIG. 6 and FIG. 7. FIG. 4 is a schematic view of a software construction interface of the enterprise process construction system according to the first embodiment of the present disclosure. FIG. 5 is a schematic view of a workflow processing interface according to the first embodiment. FIG. 6 is a schematic view of a user group building page according to the first embodiment. FIG. 7 is a schematic view of workflows of an organization role group according to the first embodiment.

After selecting the data structure template of the first information, the server 9 provides a workflow processing interface DP through the interactive program to construct a plurality of workflows, so as to respectively process the multiple pieces of first information. In other words, the server 9 will provide one or multiple ones of the workflow processing interface DP for the user to write information workflow. The information workflow is a variable, a processing formula or a process for processing the first information (e.g., “x+y=z”), or can be other conditional expressions, loops, etc. The workflow processing interface DP includes a plurality of information processing elements DPC. The information processing elements DPC include an addition element, a deletion element or a connection element.

In this embodiment, a variable processing page and a page processing page are listed separately. In other embodiments, the variable processing page and the page processing page can be set on the same page at the same time, but the present disclosure is not limited thereto.

In the enterprise process construction of this embodiment, the variables, the processing formulas or the processes of the first information are arranged into a tabular format. A fast and convenient information processing element is also provided for the user to process addition or deletion of the variables of the first information, or connections between the variables. In this way, the structured process of information processing can be effectively improved.

The variables, the formulas or the processes that process the first information are processed in coordination with adjustment parameters of visualization elements of the page, so as to effectively improve the user efficiency in processing the first information and significantly reduce the time spent by the user.

The process construction template TP1 includes at least one page PG1. That is, the process construction template TP1 may include a plurality of pages PG1-PGN. Each of the pages PG1-PGN includes a plurality of visualization elements VC1-VCN. The visualization elements VC1-VCN can be interconnected with the above-mentioned information workflow. That is, the visualization elements VC1-VCN in the page all present the first information or a content of the processed first information.

The server 9 generates a first software according to the information collected by the interactive program and the at least one page PG1 of the process construction template TP, the selected platform SP1-SPN, and the multiple pieces of first information.

In this embodiment, the process construction template TP is predetermined to be stored in the database DB of the storage device 92 by the server 9. Moreover, the server 9 can respectively provide suitable process construction templates according to the platforms selected by the user. In addition, the user can choose multiple ones of the platforms at the same time. The server 9 will be adjusted according to various pieces of data subsequently provided by the user, so as to compile software programs appropriate for different platforms.

In addition, the platform SP1-SPN may be a website platform, a MACOS® platform, an IOS® platform, an IPadOS® platform, an ANDROID® platform, a WINDOWS® platform, or a LINUX® platform.

In this embodiment, a content of the information workflow can be adjusted in coordination with the adjustment parameters of the visualization elements VC1-VCN of the at least one page PG1.

Reference is made to FIG. 6 and FIG. 7. The server 9 provides a user group building page UDP through the interactive program to establish one or more than one user group UG. The user group UG includes a plurality of users. The user group building page UDP at least includes a user authority adjustment element to adjust a usage authority of the users in the user group UG with respect to the first software. That is, the enterprise process construction system SYS1 in this embodiment separates groups of an access control list and related permissions into a design process, so that the user can reduce the time for adjusting personnel and permissions.

In this embodiment, the user authority adjustment element is selected by checking. In other embodiments, user authority adjustment may be performed in other manners. In this embodiment, the user can establish an organization role group ORGP in advance, establish different workflows according to different organizational roles, and then correspondingly associate the multiple users in the user group UG with the different organizational roles in the organization role group ORGP. In this way, even if the multiple users in the user group UG are changed, the enterprise process construction system SYS1 can quickly adjust the workflows and the relationship between the organizational roles and the users.

In addition, the server 9 of the enterprise process construction system SYS1 provides the first software to a service server (not shown) for downloading and operation. The first software includes a first front-end system, a first back-end system, and a first database system. The first front-end system is connected to the first back-end system. The first back-end system is connected to the first database system. The first front-end system is disposed in a first server, the first back-end system is disposed in a second server, and the first database system is disposed in a third server. In other embodiments, the first front-end system, the first back-end system and the first database can be disposed in the same server.

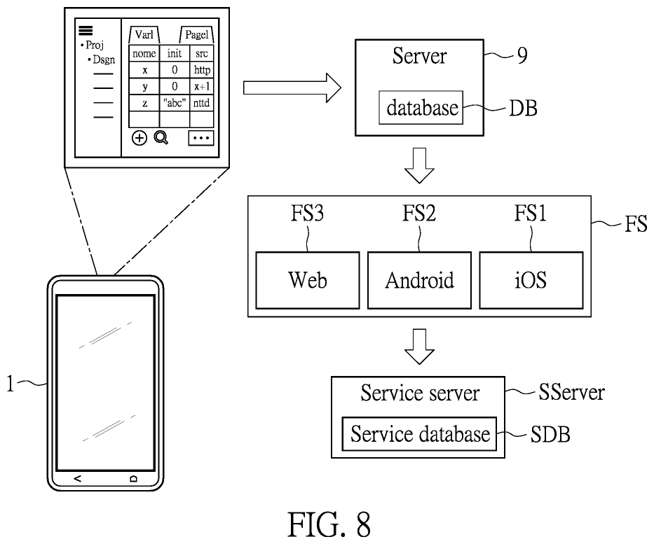

Referring to FIG. 8, FIG. 8 is a schematic view showing design parameters of a first software of the present disclosure being transmitted to a server for compilation.

After the user designs a first software FS on the software construction interface SCP of the electronic device 1, design data will be transmitted to the server 9. The server 9 compiles the design data of the first software FS to generate a first software FS1, a first software FS2 and a first software FS3 that can operate on different platforms. Then, the server 9 transmits the first software FS1, the first software FS2 and the first software FS3 to a service database SDB of a service server S Server for storage, so that the user can download and install the same.

### Second Embodiment

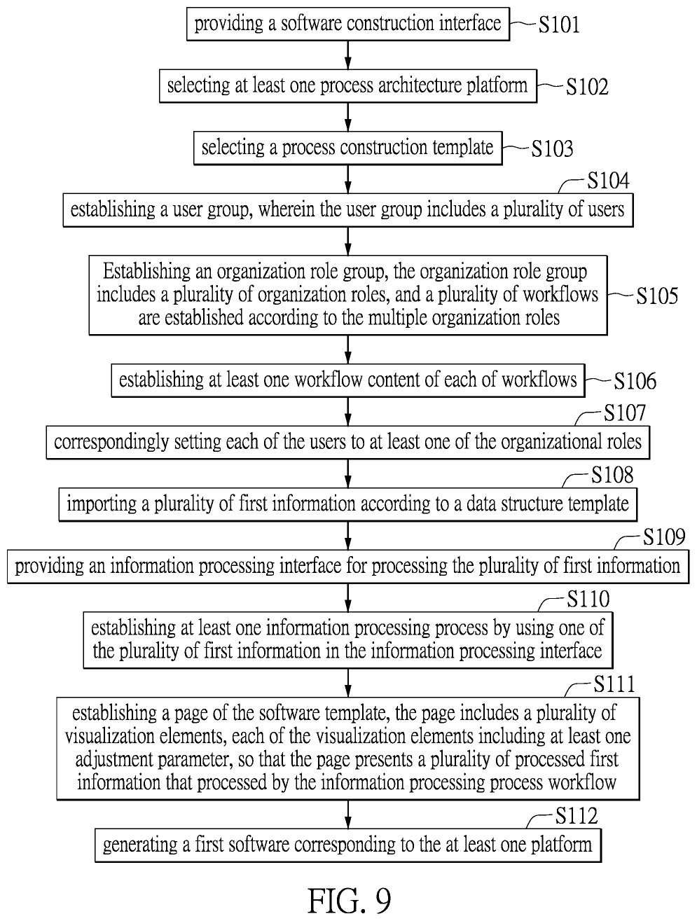

Reference is made to FIG. 9. FIG. 9 is a flowchart of an enterprise process construction method according to a second embodiment of the present disclosure.

The enterprise process construction method of this embodiment can be adapted to the enterprise process construction system SYS1 of the previous embodiment, and the structure and functions of the enterprise process construction system SYS1 will not be reiterated herein.

The enterprise process construction method includes steps as follows.

Step S101: providing a software construction interface.

Step S102: selecting at least one platform.

Step S103: selecting a process construction template.

Step S104: establishing a user group, in which the user group includes a plurality of users.

Step S105: establishing an organization role group, in which the organization role group includes a plurality of organization roles, and a plurality of workflows are established according to the multiple organization roles.

Step S106: establishing at least one workflow content of each of the workflows.

Step S107: correspondingly associating each of the users with at least one of the organizational roles.

Step S108: importing multiple pieces of first information according to a data structure template.

Step S109: providing an information processing interface for processing the multiple pieces of first information.

Step S110: establishing at least one information processing process by using one of the multiple pieces of first information in the information processing interface, in which the information processing interface workflow processing interface includes at least one information processing element.

Step S111: establishing a page of the process construction template, in which the page includes a plurality of visualization elements, each of the visualization elements including at least one adjustment parameter, so that the page presents a plurality of processed first information that are processed by the information processing process workflow.

Step S112: generating a first software corresponding to the at least one platform.

In step S100 and step S101, the enterprise process construction system SYS1 of this embodiment includes a server 9. The server 9 is connected to an electronic device 1. The electronic device 1 can be connected to and interact with the server 9 through an interactive program installed in the electronic device 1.

The interactive program in the electronic device 1 first provides a software construction interface SCP for performing a plurality of software construction actions. The server 9 provides a plurality of platforms SP1-SPN for selection through the interactive program.

In this embodiment, the process construction template is predetermined to be stored in a database DB of a storage device 92 by the server 9. Moreover, the server 9 can respectively provide suitable process construction templates according to the platforms selected by the user. In addition, the user can select multiple ones of the platforms at the same time. The server 9 will be adjusted according to various pieces of data subsequently provided by the user, so as to compile software programs appropriate for different platforms. In addition, while the user selects the multiple platforms, software construction can be performed at the same time. For example, an ANDROID® platform and an IOS® platform can be simultaneously selected.

In steps S102 and S103, when one of the platforms SP1-SPN is selected, the server 9 will provide a plurality of process construction templates TP1 for selection.

In addition, in this embodiment, the enterprise process construction system SYS1 can provide a plurality of data structure templates for the user to select, and can also allow the user to import or receive multiple pieces of first information. Input of the first information can be performed according to one of the data structure templates provided by the server 9, or can be performed according to a user-defined data structure template. In other words, the enterprise process construction system SYS1 of the present embodiment allows the user to process data freely.

In this embodiment, the first information is Internet of Things information (IoT) collected from Internet of Things devices. To be more specific, the first information can be basic detection information that is unorganized or unprocessed, or can be information having a format that is clearly defined by other devices. Furthermore, the user can input data of various data structures for editing and analysis.

After selecting the data structure template of the first information, the server 9 provides a workflow processing interface DP through the interactive program to construct a plurality of workflows, so as to respectively process the multiple pieces of first information. In other words, the server 9 will provide one or multiple ones of the workflow processing interface DP for the user to write the information workflow. The information workflow is a variable, a processing formula or a process for processing the first information (e.g., “x+y=z”), or can be other conditional expressions, loops, etc. The workflow processing interface DP includes a plurality of information processing elements DPC. The information processing elements DPC include an addition element, a deletion element or a connection element.

In steps S104 to S107, the server 9 provides a user group building page UDP through the interactive program to establish one or more than one user group UG. The user group UG includes a plurality of users. The user group building page UDP at least includes a user authority adjustment element to adjust a usage authority of the users in the user group UG with respect to the first software. That is, the enterprise process construction system SYS1 in this embodiment separates groups of an access control list and related permissions into a design process, so that the user can reduce the time for adjusting personnel and permissions. In this embodiment, the user authority adjustment element is selected by checking. In other embodiments, user authority adjustment may be performed in other manners. In this embodiment, the user can establish an organization role group ORGP in advance, establish different workflows according to different organizational roles, and then correspondingly associate the multiple users in the user group UG with the different organizational roles in the organization role group ORGP. In this way, even if the multiple users in the user group UG are changed, the enterprise process construction system SYS1 can quickly adjust the workflows and the relationship between the organizational roles and the users.

In steps S108 to S112, the process construction template TP1 includes at least one page PG1. That is, the process construction template TP1 may include a plurality of pages PG1-PGN. Each of the pages PG1-PGN includes a plurality of visualization elements VC1-VCN. The visualization elements VC1-VCN can be interconnected with the above-mentioned information workflow. That is, the visualization elements VC1-VCN in the page all show the first information or a content of the processed first information.

In this embodiment, a content of the information workflow can be adjusted in coordination with the adjustment parameters of the visualization elements VC1-VCN of the at least one page PG1.

In step S112, the server 9 generates a first software according to the information collected by the interactive program and the at least one page PG1 of the process construction template TP, the selected platform SCP, and the multiple pieces of first information.

In addition, in the enterprise process construction system SYS1 of this embodiment, the server 9 provides the first software to a service server (not shown) for downloading and operation.

### Beneficial Effects of the Embodiments

In conclusion, the enterprise process construction system and the enterprise process construction method provided by the present disclosure can be easily constructed based on practical requirements of an enterprise. In addition, since the processes can be quickly adjusted according to user requirements, the enterprise process construction system and the enterprise process construction method can be adapted for various platforms, and maintenance thereof is simple. Accordingly, design costs can be effectively reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An enterprise process construction system, comprising:
a server being connected to an electronic device, the electronic device being connected to the server through an interactive program installed in the electronic device;
wherein the interactive program provides a software construction interface to perform a plurality of software construction actions, the server provides a plurality of platforms for selection through the interactive program, the server provides a plurality of process construction templates for selection, and multiple pieces of first information are imported based on one of a plurality of data structure templates;
wherein a user group and an organization role group are established in the software construction interface of the interactive program, the user group includes a plurality of users, the organization role group includes a plurality of organization roles and a plurality of workflows that correspond to the plurality of organization roles, and each of the plurality of users is correspondingly associated with at least one of the plurality of organization roles in the organization role group;
wherein the server provides a workflow processing interface to construct the plurality of workflows, so as to respectively process the multiple pieces of first information; wherein the workflow processing interface includes a plurality of information processing elements;
wherein the process construction template includes at least one page, the at least one page includes a plurality of visualization elements, each of the visualization elements includes an adjustment parameter, and the plurality of visualization elements are interconnected with the plurality of workflows to show the first information or processed first information;
wherein the server generates a first software according to information collected by the at least one page of the process construction template in the software construction interface provided by the electronic device, the selected platform, and the multiple pieces of first information.

2. The enterprise process construction system according to claim 1, wherein the platform is a website platform, a MACOS® platform, an IOS® platform, an IPADOS® platform, an ANDROID® platform, a WINDOWS® platform, or a LINUX® platform.

3. The enterprise process construction system according to claim 1, wherein the first software includes a first front-end system, a first back-end system, and a first database system, the first front-end system is connected to the first back-end system, and the first back-end system is connected to the first database system.

4. The enterprise process construction system according to claim 3, wherein the first front-end system is disposed in a first server, the first back-end system is disposed in a second server, and the first database system is disposed in a third server.

5. The enterprise process construction system according to claim 3, wherein the first front-end system, the first back-end system, and the first database system are disposed in a same server.

6. The enterprise process construction system according to claim 3, wherein the information processing elements include an addition element, a deletion element or a connection element.

7. The enterprise process construction system according to claim 6, wherein the server provides a user group building page through the interactive program to establish one or multiple ones of the user group, the user group building page further includes a user authority adjustment element to adjust a usage authority of the plurality of users in the user group with respect to the first software, and the server provides the first software to a service server for downloading and operation.

8. An enterprise process construction method, comprising:
providing a software construction interface;
selecting a process construction template;
establishing a user group, the user group including a plurality of users;
establishing an organization role group, wherein the organization role group includes a plurality of organization roles, and a plurality of workflows are established according to the organization roles;
establishing at least one workflow content of each of the workflows; correspondingly associating each of the users with at least one of the organizational roles;
importing multiple pieces of first information based on a data structure template;
providing a workflow processing interface to process the plurality of first information;
establishing at least one information processing workflow by using one of the plurality of first information in the information processing interface, wherein the workflow processing interface includes at least one information processing element;
establishing a page of the process construction template, wherein the page includes a plurality of visualization elements, and each of the visualization elements includes at least one adjustment parameter, so that the page presents processed first information after the multiple pieces of first information undergo the at least one information processing workflow; and
generating a first software corresponding to the at least one platform.

9. The enterprise process construction method according to claim 8, wherein a content of the at least one information workflow is adjusted in coordination with the adjustment parameters of the visualization elements of the page.

10. The enterprise process construction method according to claim 9, wherein the at least one platform is a website platform, a MACOS® platform, an IOS® platform, an IPADOS® platform, an ANDROID® platform, a WINDOWS® platform, or a LINUX® platform, the first information is Internet of Things information, and the information processing element includes an addition element, a deletion element or a connection element.
